(19) United States
(12) Patent Application Publication
(10) Pub. No.: US 2016/0380867 A1
(43) Pub. Date: Dec. 29, 2016

(54) Method and System for Detecting and Identifying Assets on a Computer Network

(71) Applicant: Above Security Inc., Blainville (CA)

(72) Inventors: Nicandro Scarabeo, Montreal (CA); Thierry Laurion, Montreal (CA); Guillaume Daleux, Montreal (CA)

(21) Appl. No.: 15/188,837

(22) Filed: Jun. 21, 2016

Related U.S. Application Data
(60) Provisional application No. 62/183,468, filed on Jun. 23, 2015.

(51) Int. Cl. H04L 12/26; H04L 12/859

(52) U.S. Cl. CPC H04L 43/10; H04L 47/2475; H04L 47/286

(57) ABSTRACT

A computer-implemented method for identifying an asset of a computer machine performed using at least one processing unit for: capturing an update packet from a data path connected to the computer machine; extracting application layer data related to the asset to be identified from the update packet; identifying the asset using the extracted application data layer; and outputting the identification of the asset.

### RELATED APPLICATIONS

This application claims priority to U.S. Provisional Application Ser. No. 62/183,468, filed Jun. 23, 2015, which is incorporated herein by reference in its entirety.

### TECHNICAL FIELD

The present invention relates to the field of computer asset identification, and more particularly to methods and systems for detecting and identifying assets on a computer network.

### BACKGROUND

Asset detection represents a critical task in several activities related to computer network and security. For example, network administrators need to maintain an up-to-date inventory of important assets within their computer network. Similarly, security administrators need to be aware of existing assets in order to determine the criticality and the severity of security incidents.

Computer assets may comprise software assets such as operating systems, services, applications, or the like, and hardware equipment such as workstations or computer machines, servers, routers, and the like.

Because of the increasing number of software and hardware assets that appear on computer networks and the rapid evolution of software assets, relying on manual audits or static inventory has become impractical in certain circumstances. Various techniques for detecting assets on a computer network have been developed. Two main categories of asset detection techniques exist, i.e. passive asset detection methods which passively monitor traffic and active asset detection methods in which one or more packets are sent to a computer machine to induce traffic. While they may provide more accurate results than passive techniques, active techniques may disrupt the function of the computer machines being tested or their network. Therefore, passive tools may be advantageous in situations where injecting traffic is not allowed or not recommended.

The accuracy of an asset detection tool depends not only on the mode of operation, i.e. passive mode versus active mode, but it also depends on the underlying method of detection as well as the quality and the completeness of its fingerprint database. It happens that current implementations of both techniques may fail completely to identify, may misidentify some assets or may only partially identify an asset, for example identifying only the asset family rather than the exact product, e.g. Windows rather than Windows XP. Lack of knowledge or inaccurate or erroneous knowledge about assets may negatively affect the results of all depending tools or activities. This may lead to wrong decisions and/or actions being taken in connection with the computer network. Moreover, some of the actual asset detection tools support only the detection of operating systems and service applications and they do not support the detection of non-service applications that are installed or run on computers without having network interactions.

Therefore, there is a need for an improved method and system for detecting and identifying computer assets on a computer network.

### SUMMARY

According to a first broad aspect, there is provided a computer-implemented method for identifying an asset of a computer machine performed using at least one processing unit for: capturing an update packet from a data path connected to the computer machine; extracting application layer data related to the asset to be identified from the update packet; identifying the asset using the extracted application data layer; and outputting the identification of the asset.

In some embodiments, the step of capturing an update packet comprises capturing an update packet propagating towards the computer machine.

In some other embodiments, the step of capturing an update packet comprises capturing an update packet propagating from the computer machine.

In some embodiments, the step of capturing an update packet comprises capturing a given packet and identifying the given packet as being the update packet.

In some embodiments, the step of identifying the given packet as being the update packet comprises: decoding an Internet Protocol (IP) header of the given packet and extracting information contained in the decoded IP header; determining whether the given packet belongs to a Transmission Control Protocol (TCP) traffic using the information extracted from the IP header; if the given packet does not belong to TCP traffic, discarding the given packet; and if the given packet belongs to the TCP traffic, reconstructing a TCP flow, and determining that the given packet is the update packet using the reconstructed TCP flow via protocol identification.

In some embodiments, the step of extracting information contained in the decoded IP header comprises extracting at least one of a IP version, a source IP, a destination IP, and a time-to-live.

In some embodiments, the step of identifying the asset comprises generating a given fingerprint using the application layer data and comparing the given fingerprint to reference fingerprints each corresponding to a respective asset identification.

In some embodiments, each respective asset identification comprises at least one of a name and a version.

In some embodiments, the step of generating the given fingerprint comprises extracting some of the application layer data.

In some embodiments, the extracted application data layer comprises a given value for at least one of a MajorVersion, a MinorVersion, a SuiteMask, an OldProductType, a NewProductType, a SystemMetrics, and a ProcessorArchitecture.

In some embodiments, the method further comprises determining whether the update packet is one of a Windows packet and a Unix-like packet.

In an embodiment in which the update packet is a Windows packet, the step of extracting application layer data comprising extracting a WSUS SOAP message from the update packet and parsing WSUS fields contained in the WSUS message, and the step of identifying the asset comprises generating a given Windows fingerprint using the parsed WSUS fields and comparing the given Windows fingerprint to reference Windows fingerprints.

In some embodiments, the method further comprises detecting and identifying at least one of an application and a hardware component for the computer machine using the given Windows fingerprint.

In some embodiments, the method further comprises determining whether the update packet is one of an FTP packet and a HTTP packet when the update packet is a Unix-like packet.

In an embodiment in which the update packet is an FTP packet, the step of extracting application layer data comprising extracting an FTP transfer setup and parsing and analysing an FTP request message, and the step of identifying the asset comprises generating a given Unix fingerprint using the parsed FTP request message and comparing the given Unix fingerprint to reference Unix fingerprints.

In an embodiment in which the update packet is a HTTP packet, the step of extracting application layer data comprising extracting a HTTP header and parsing and analysing HTTP fields, and the step of identifying the asset comprises generating a given Unix fingerprint using the HTTP fields and comparing the given Unix fingerprint to reference Unix fingerprints.

In some embodiments, the method further comprises detecting and identifying at least one of an application and a hardware component for the computer machine using the given Unix fingerprint.

According a second broad aspect, there is provided an asset detector comprising at least a processing unit, a memory, and communication means for receiving and transmitting data, the memory having stored thereon instructions that upon execution by the processing unit perform the steps of the above-described method.

According to a third broad aspect, there is provided a computer program product comprising a computer readable memory storing computer executable instructions thereon that when executed by a computer perform the method steps of the above-described method.

According to another broad aspect, there is provided a computer-implemented method for detecting and identifying computer assets on a computer network, performed using at least one processing unit for: capturing update packets from the computer network, the computer network comprising a plurality of computer machines; and for each one of the captured update packets: identifying a corresponding one of the computer machines that is related to the captured update packet; extracting application layer data from the captured update packet; identifying an asset of the corresponding computer machine using the extracted application data layer; and outputting the identified asset and an identification of the corresponding computer machine.

In some embodiments, the step of capturing update packets comprises capturing update packets propagating towards the computer machine.

In some other embodiments, the step of capturing update packets comprises capturing update packets propagating from the computer machine.

In some embodiments, the step of capturing update packet comprises capturing given packets and identifying the given packets as being the update packets.

In some embodiments, the step of identifying the given packets as being the update packets comprises for each given packet: decoding an Internet Protocol (IP) header of the given packet and extracting information contained in the decoded IP header; determining whether the given packet belongs to a Transmission Control Protocol (TCP) traffic using the information extracted from the IP header; if the given packet does not belong to TCP traffic, discarding the given packet; and if the given packet belongs to the TCP traffic, reconstructing a TCP flow, and determining that the given packet is the update packet using the reconstructed TCP flow via protocol identification.

In some embodiments, the step of extracting information contained in the decoded IP header comprises extracting at least one of a IP version, a source IP, a destination IP, and a time-to-live.

In some embodiments, the step of identifying the asset comprises generating a given fingerprint using the application layer data and comparing the given fingerprint to reference fingerprints each corresponding to a respective asset identification.

In some embodiments, each respective asset identification comprises at least one of a name and a version.

In some embodiments, the step of generating the given fingerprint comprises extracting some of the application layer data.

In some embodiments, the extracted application data layer comprises a given value for at least one of a MajorVersion, a MinorVersion, a SuiteMask, an OldProductType, a NewProductType, a SystemMetrics, and a ProcessorArchitecture.

In some embodiments, the method further comprises determining whether each update packet is one of a Windows packet and a Unix-like packet.

In an embodiment in which the update packet is a Windows packet, the step of extracting application layer data comprising extracting a WSUS SOAP message from the update packet and parsing WSUS fields contained in the WSUS message, and the step of identifying the asset comprises generating a given Windows fingerprint using the parsed WSUS fields and comparing the given Windows fingerprint to reference Windows fingerprints.

In some embodiments, the method further comprises detecting and identifying at least one of an application and a hardware component for the computer machine using the given Windows fingerprint.

In some embodiments, the method further comprises determining whether the update packet is one of an FTP packet and a HTTP packet when the update packet is a Unix-like packet.

In an embodiment in which the update packet is an FTP packet, the step of extracting application layer data comprising extracting an FTP transfer setup and parsing and analysing an FTP request message, and the step of identifying the asset comprises generating a given Unix fingerprint using the parsed FTP request message and comparing the given Unix fingerprint to reference Unix fingerprints.

In an embodiment in which the update packet is a HTTP packet, the step of extracting application layer data comprising extracting a HTTP header and parsing and analysing HTTP fields, and the step of identifying the asset comprises generating a given Unix fingerprint using the HTTP fields and comparing the given Unix fingerprint to reference Unix fingerprints.

In some embodiments, the method further comprises detecting and identifying at least one of an application and a hardware component for the computer machine using the given Unix fingerprint.

In some embodiments, the step of said identifying a corresponding one of the computer machines is performed using an IP address associated with the update packet.

According to a further broad aspect, there is provided an asset detector comprising at least a processing unit, a memory, and communication means for receiving and transmitting data, the memory having stored thereon instructions that upon execution by the processing unit perform the steps of the above-described method.

According to still another broad aspect, there is provided a computer program product comprising a computer readable memory storing computer executable instructions thereon that when executed by a computer perform the method steps of the above-described method.

### BRIEF DESCRIPTION OF THE DRAWINGS

Further features and advantages of the present invention will become apparent from the following detailed description, taken in combination with the appended drawings, in which:

FIG. 1 is a block diagram of a computer network provided with an asset detection system, in accordance with an embodiment;

FIG. 2 is a block diagram of an asset detector, in accordance with an embodiment;

FIG. 3 is a flow chart illustrating a method for detecting and identifying an asset provided on a computer machine, in accordance with an embodiment;

FIG. 4 is a block diagram illustrating the data flow between a computer machine, an update server and a web update repository, in accordance with an embodiment;

FIG. 5 is a flow chart illustrating a method for extracting and identifying update packets from a data stream, in accordance with an embodiment;

FIG. 6 illustrates a method for generating a fingerprint for a packet using data application information contained within the packet, in accordance with an embodiment;

FIGS. 7a and 7b are flow charts illustrating a method for detecting and identifying Windows operating systems and Linux operating systems using update packets, in accordance with an embodiment; and

FIG. 8 is a flow chart illustrating a method of identifying an asset on a given computer machine present on a computer network and identifying the given computer machine, in accordance with an embodiment.

It will be noted that throughout the appended drawings, like features are identified by like reference numerals.

### DETAILED DESCRIPTION

In some embodiments, a passive method and system detect and identify an asset of a computer machine, i.e. the method and system identify an asset of the computer machine without performing any scan. In some embodiments, a method and system for detecting and identifying assets present on a computer network which comprises a plurality of computer machines. In such embodiments, the method and system are adapted to detect and identify an asset and further identify the given computer machine on which the identified asset is installed.

An asset of a computer machine may be a software asset such as an operating system, a service, an application, or the like. An asset of a computer machine may also be hardware piece of equipment contained in the computer machine or connected to the computer machine such as a printer, a monitor, a scanner, a sound card, a video card, or the like.

An asset of a computer network comprising a plurality of computer machines may be a software asset installed on a given computer machine such as an operating system, a service, an application, or the like. An asset of a computer network may also be hardware equipment such as a workstation or computer machine, a server, a router, and the like.

In some embodiments, the present methods and systems can detect an asset and determine at least one characteristic of the detected asset for identification purposes. For example, the present methods and systems may detect and identify an operating system, a running service, the exact name and version of an installed application, and/or the like. The asset detection and identification performed by the methods and systems may allow a user to record a history of changes for the detected assets.

In some embodiments, a method detects and identifies an asset on a computer network while using a plurality of different asset identification techniques. Different asset identification techniques may provide different identification results. For example, a first identification method may identify a given operating system running on a given computer machine as being Windows™ while a second and different identification method may identify the given operating system as being Linux™. In this case, the present method and system allow determining which of one the different identification results is the true or correct identification.

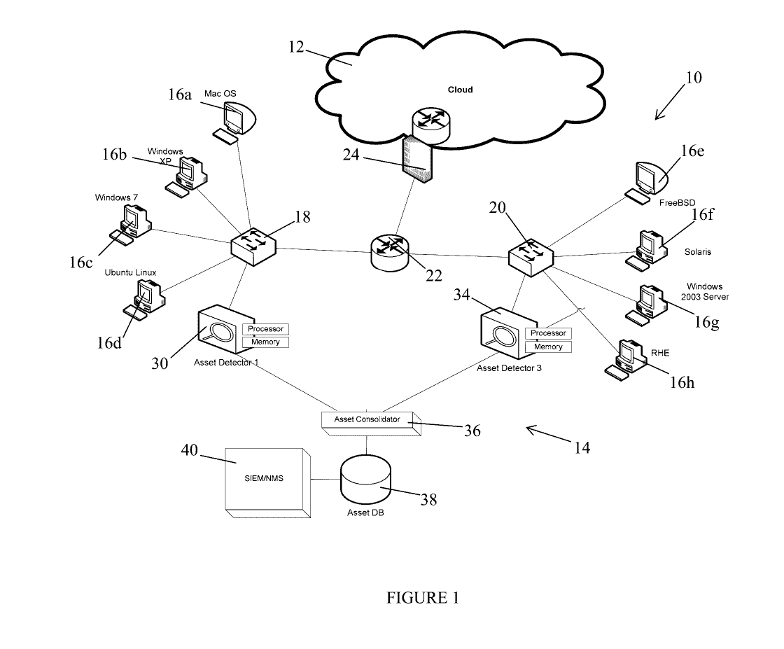

FIG. 1 illustrates a computer network 10 which is connected to a telecommunication network such as the cloud 12 in accordance with some embodiments. An asset detection system 14 is connected to the computer network 10 in order to determine and identify the assets contained in the computer network 10.

The computer network 10 comprises a plurality of computer machines 16a-16h, two switches 18 and 20, a router 22, and a firewall 24. The computer machines 16a-16d are all connected to the first switch 18 while the other computer machines 16e-16h are each connected to the second switch 20. The two switches 18 and 20 are each connected to the router 22 which is connected to the cloud 12 via the firewall 24. As illustrated in FIG. 1, different operating systems may run on at least some of the computer machines 16a-16h. For example, a Mac operating system may run on the computer machine 16a and Windows XP may run on the computer machine 16b while Windows 7 runs on the computer machine 16c and Ubuntu Linux may run on the computer machine 16d. Similarly, FreeBSD may run on the computer machine 16e and Solaris may run on the computer machine 16f while Windows 2003 Server may run on the computer machine 16g and Red Hat Enterprise (RHE) may run on the computer machine 16h. It should be understood that the above-listed operating systems for the computer machines 16a-16h are exemplary only.

It should also be understood that the computer network 10 is exemplary only. The number and the type of components/elements contained in the computer network 10 may vary. For example, while it comprises eight computer machines 16a-16h, the number of computer machines may vary as long as the computer network 10 comprises at least two computer machines. Similarly, the number of switches and/or routers may also vary. It should also be understood that the architecture of the computer network may vary. For example, the computer network may comprise four switches each being connected to two respective computer machines 16a-16h. In another example, a computer network may comprise multiple Local Area Network (LAN) segments connected to a router access to the Internet, and an asset detector may be connected to the router. Each LAN segment may comprise several computer machines connected together through a switch to which an asset detector is connected.

The asset detection system 14 comprises two asset detectors 30 and 34 and an asset consolidator 36. Each asset detector 30, 34 comprises at least a processing unit, a memory, a communication interface (e.g., a network interface or bus interface) and a communication module for receiving and/or transmitting data. Each asset detector 30, 34 is adapted to detect and identify assets by analyzing the data traffic at one point in the computer network 10. For example, the asset detector 30 may monitor the data traffic passing through the switch 18 in order to identify assets that are contained in the group of computer machines 16a-16d and the asset detector 34 may monitor the data traffic passing through the switch 20 in order to identify assets that are contained in the group of computer machines 16e-16h. Each asset detector 30, 34 is adapted to transmit the detected and identified assets to the asset consolidator 36. In an embodiment in which the identifications of a given asset received from the two asset detectors 30 and 34 are different, the asset consolidator 36 is adapted to determine the correct identity of the asset, as described below.

In some embodiments, the two asset detectors 30 and 34 are adapted to use different asset detection techniques to identify assets on the computer network 10. For example, the asset detector 30 may be adapted to use a passive detection technique to identify the assets of the computer machines 16a-16d while the asset detector 34 may be adapted to use an active asset detection technique to identify the assets of the computer machines 16a-16d.

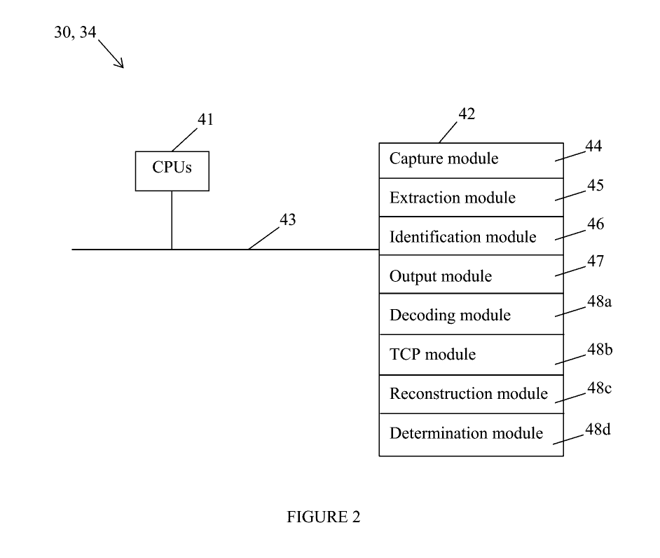

In some embodiments, at least a given one of the asset detectors 30 and 34 is adapted to execute the passive computer-implemented detection method 50 illustrated in FIG. 2. The given asset detector may be connected to the communication link between a given computer machine and a switch so that the identity of given computer machine is already known. For example, the given asset detector may be connected to the communication link or data path between the switch 18 and the computer machine 16a. In this case, the identity of the computer machine 16a is already known and any asset identified by the asset detector will be considered as belonging to the computer machine 16a.

In this case, the memory of the given asset detector comprises statements and/or instructions stored thereon that, when executed by the processing unit of the given asset detector, perform the steps of the method 50.

FIG. 2 illustrates is a block diagram illustrating an exemplary asset detector 30, 34, in accordance with some embodiments. The asset detector 30, 34 typically comprises one or more processing units (CPUs) 41 for executing modules, programs and/or instructions stored in memory 42 and thereby performing processing operations, memory 42, and one or more communication buses 43 for interconnecting these components. Communication buses 43 optionally include circuitry (sometimes called a chipset) that interconnects and controls communications between system components. The memory 42 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 42 optionally includes one or more storage devices remotely located from the CPU(s) 41. The memory 42, or alternately the non-volatile memory device(s) within the memory 42, comprises a non-transitory computer readable storage medium. In some embodiments, the memory 42, or the computer readable storage medium of the memory 42 stores the following programs, modules, and data structures, or a subset thereof:

a capture module 44 for capturing update packets from a data path;

an extraction module 45 for extracting data relative to an asset to be identified from captured packets;

an identification module 46 for identifying an asset using the extracted information; and

an output module 47 for outputting the identified asset.

In some embodiments, the memory 42 optionally includes the following modules or sub-modules, or a subset thereof:

a decoding module 48a for decoding the IP header of a captured packet;

a TCP module 48b for determining whether a captured packet belongs to TCP traffic

a reconstruction module 48c for reconstructing the TCP flow of a captured packet; and

a determination module 48d for determining whether a captured packet is an update packet using a reconstructed TCP flow.

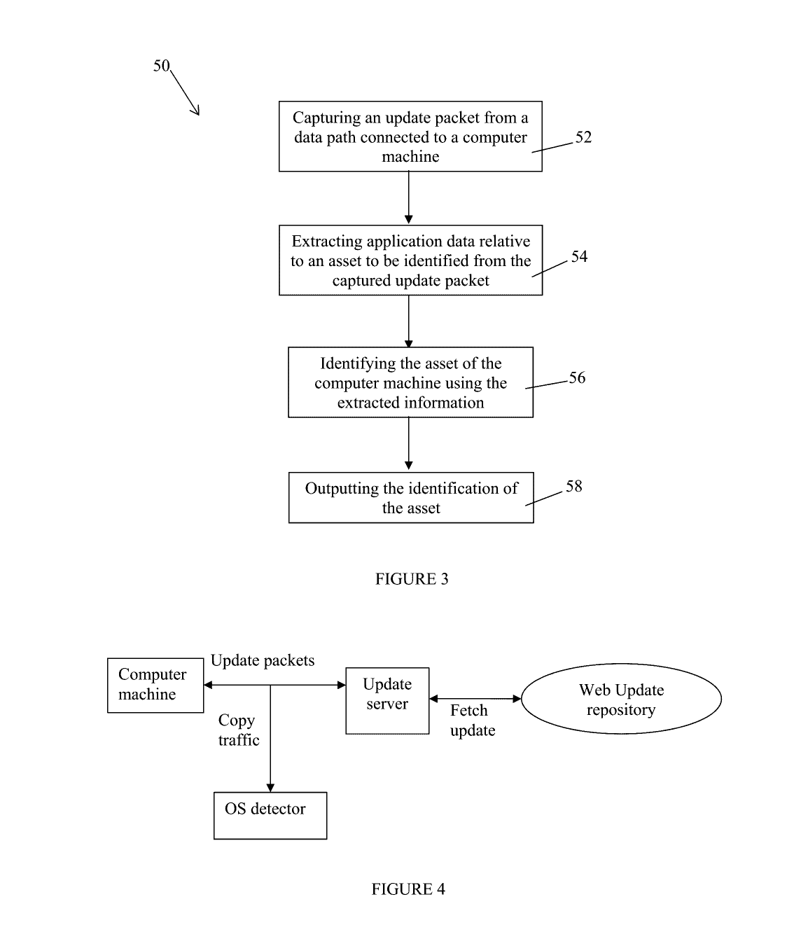

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, the memory 42 may store a subset of the modules and data structures identified above. Furthermore, the memory 42 may store additional modules and data structures not described above. In some embodiments, the programs, modules, and data structures stored in the memory 42, or the computer readable storage medium of the memory 42, provide instructions for implementing any of the methods described below with reference to FIGS. 3, 5, 7a, 7b, and 8.

Although FIG. 2 shows an asset detector 30, 34, FIG. 2 is intended more as functional description of the various features which may be present in a management module than as a structural schematic of the embodiments described herein. In practice, and as recognized by those of ordinary skill in the art, items shown separately could be combined and some items could be separated.

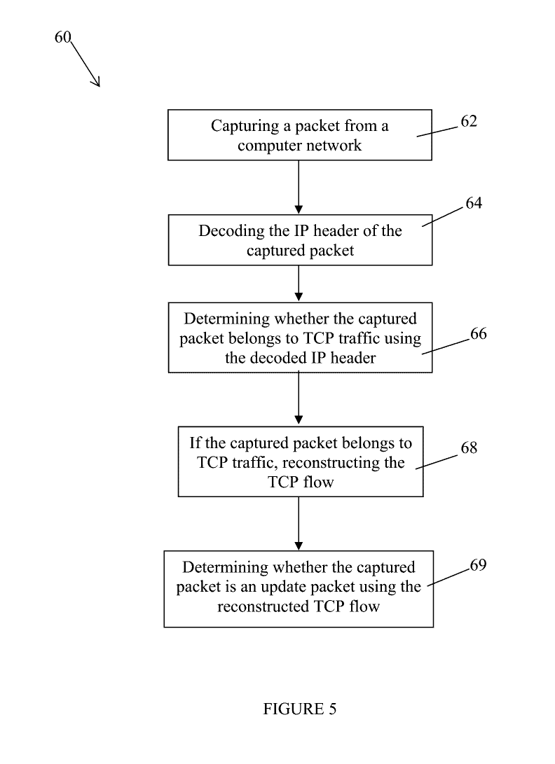

Referring to FIG. 3, there is described one embodiment of a method 50 for passively identifying at least one asset of a given computer machine. The first step 52 consists in analysing a data stream propagating to or from the given computer machine and capturing an update packet contained in the data stream. As illustrated in FIG. 4, update packets usually propagate between a computer machine and an update server which is connected to a web update repository. An operating system detector is listening to the data stream happening between the computer machine and the update server to obtain a copy of the update packets propagating between the computer machine and the update server.

At step 54, application layer data is extracted from the application layer of the captured update packet. Using the extracted application layer data, an asset is identified at step 56, and the identification of the asset is outputted at step 58. For example, the determined identity of the asset may be stored in a local or external memory (e.g., in asset database 38, FIG. 1). In the same or another embodiment, the determined identity of the asset is sent to the asset consolidator 36 along with the identity of the given computer machine for example. In some embodiments, one or more security measures (e.g., limiting access by a respective asset to resources in network 10 or limiting access by one or more respective computer or other devices to the identified asset), or one or more remedial actions (e.g., sending a warning or alert message to an operator of a respective computer 16 or 40, or initiating a script or other program to undo a limit the consequences of an action taken by or corresponding to the identified asset), are performed in accordance with the determined identity of the asset.

Almost all operating systems and applications require frequent updates to fix bugs, remove vulnerabilities, add new features, etc. The computer machines then communicate with update servers on the Internet or a mirror update server on a local computer network to obtain information about the availability of new updates. When new updates become available, a computer machine connects to the update server or may be redirected to another server to download updates. During the update process, there is an initialization step during which exchange information about the asset to be updated is exchanged. Update traffic may then be adequate for the purpose of asset detection for at least some of the following reasons. First, updates are necessary for almost all operating systems and applications. Second, the determination of the availability of updates occurs frequently or on a regular basis (usually once per week) and the communication related to this determination can be monitored passively. Third, update exchange traffic contains information not only about the operating system and the service applications, but also about other installed, non-service applications. Fourth, detailed information about the asset name and version or the applied patches are usually included in the update exchange traffic. Furthermore, update communication is often exchanged in clear without any encryption.

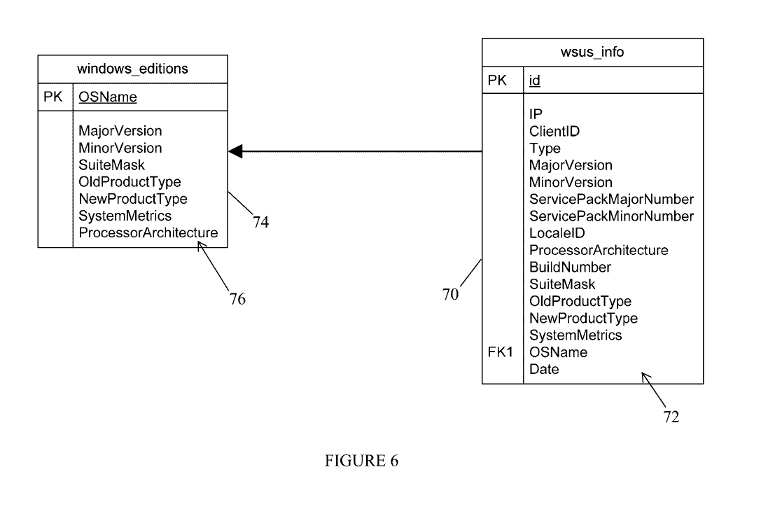

FIG. 5 illustrates one embodiment of a computer-implemented method 60 for identifying update packets in a data stream that may be used at step 52 of the method 50. At step 62, a packet is captured from the data stream. The Internet Protocol (IP) header of the captured packet is decoded at step 64. Once the IP header of the captured packet has been decoded, information contained in the IP header such as IP version, source IP, destination IP, time-to-live, and the like is accessible. Using the information contained in the IP header of the captured packet, it is determined whether the captured packet belongs to a Transport Control Protocol (TCP) data traffic.

If the captured packet does not belong to a TCP data traffic, then the captured packet is discarded since most of update traffic is built on top of TCP, and a further packet is captured and analysed to determine whether it is an update packet.

If the captured packet belongs to TCP data traffic, then the TCP flow is reconstructed at step 68. Packets belonging to a same TCP session are stacked for deep packet inspection (DPI) and protocol identification. Using the reconstructed TCP flow, it is determined whether the captured packet corresponds to an update packet via protocol identification at step 69. If the captured packet does not correspond to an update packet, the captured packet is discarded and another packet is captured and analysed. If the captured packet corresponds to an update packet, data information is extracted from the update packet as described at step 54 of method 50.

Referring back to FIG. 3, the step 56 of identifying the asset of the computer machine may comprise a step of generating a fingerprint for the captured update packet from the application layer data extracted from the captured update packet, and a step of comparing the determined fingerprint to reference fingerprints contained in a database (e.g., asset database 38, FIG. 1). The database comprises a given asset identification for each reference fingerprint stored thereon. The asset identification stored in the database may comprise the name of the asset, the version of the asset, etc. Therefore, it is possible to determine the identification of the asset by matching the determined fingerprint to a reference fingerprint.

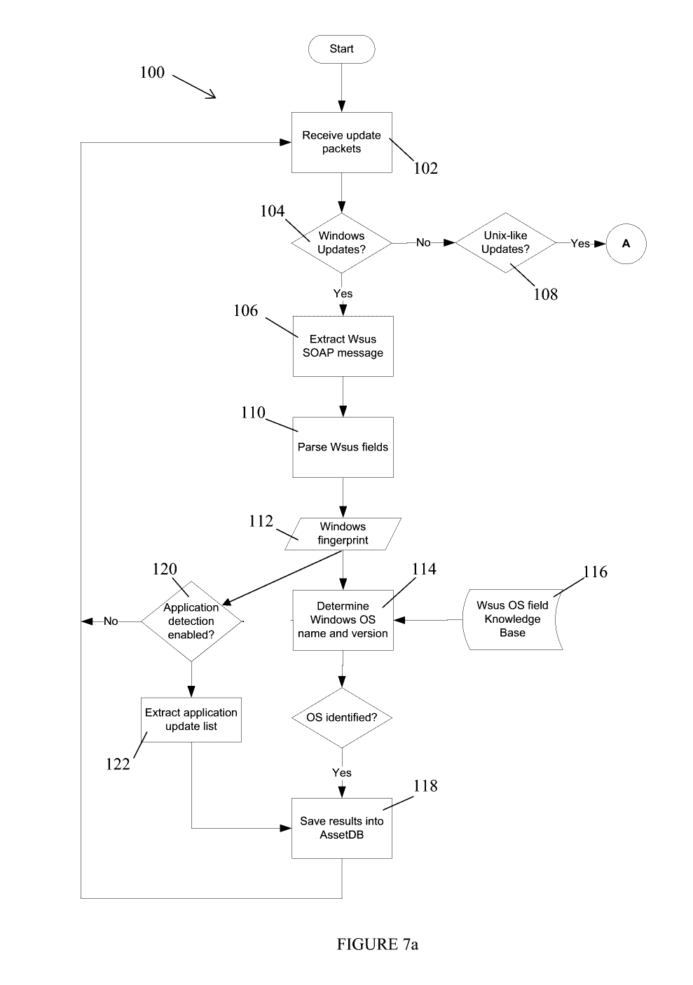

FIG. 6 illustrates one embodiment of a method of generating a fingerprint for an update packet. Table 70 illustrates exemplary layer application information 72 contained in the application layer of an update packet. For example, the application layer information 72 may comprise client identification (ID), type, MajorVersion, MinorVersion, ServicePack majorNumber, ServicePackMinorNumber, LocaleID, ProcessorArchitecture, BuildNumber, SuiteMask, OldProductType, NewProductType, SystemMetrics, OSName, Date, and/or the like. Table 74 illustrates an exemplary fingerprint generated from the application layer data 72. The fingerprint 74 comprises some application layer data 76 contained in the update packet, which is extracted from the application layer information 72, and the application layer data 76 forms the fingerprint for the update packet. The application layer data 76 comprises a value for MajorVersion, MinorVersion, SuiteMask, OldProductType, NewProductType, SystemMetrics, and ProcessorArchitecture. The other remaining application layer information that is contained in table 70 but not in table 74 is not part of the fingerprint.

Once generated, the fingerprint 74 is compared to reference fingerprints stored in a database. Each reference fingerprint comprises a respective value for the following application layer information: MajorVersion, MinorVersion, SuiteMask, OldProductType, NewProductType, SystemMetrics, and ProcessorArchitecture, and a corresponding operating system. Therefore, if the fingerprint generated for the captured update packet matches a given reference fingerprint stored in the database, the operating system associated with the given reference fingerprint is assigned to the generated fingerprint and therefore to the captured update packet.

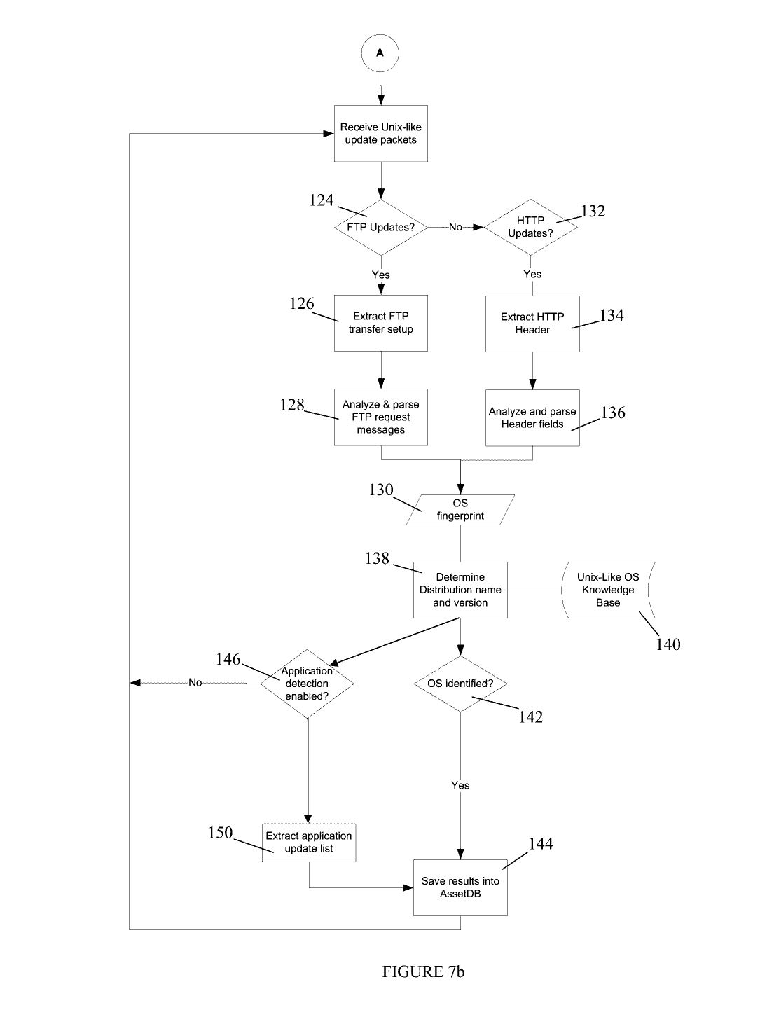

FIGS. 7a and 7b illustrate one embodiment of a computer-implemented method 100 for determining the operating system of a computer, in which it is determined whether an update packet is either a Windows™ packet or a Unix™-like packet. It should be understood that the method 100 is implemented by a computer machine, such as the asset detector 30 or 34 provided at least with a processing unit, a communication module for receiving and/or transmitting data, and a memory having stored thereon statements and/or instructions that, when executed by the processing unit, perform the steps of the method 100.

At step 102, an update packet is received. At step 104, the update packet is analyzed through deep packet inspection and it is determined whether the received update packet is a Windows™ packet through Windows Server Update Services (WSUS) application protocol detection. If the update packet is a Windows™ packet, then the method passes to step 106. If the update packet is not a Windows™ packet, it is determined whether the received update packet is a Unix™-like packet at step 108. If the received update packet is identified as a Unix™-like packet, then the method continues at step 124 on FIG. 7b

Referring back to step 104 and if the received update packet is identified as a Windows™ packet, then the WSUS Simple Object Access Protocol (SOAP) message which is a transactional request or answer, sitting upon HTTP application layer protocol, is extracted from HTTP payloads contained in the update packet at step 106. At step 110, the WSUS fields are parsed using an XML parser and fields of the SOAP message that contain information relevant to operating system are extracted. Since SOAP messages permit communication between applications and a SOAP message is delimited by boundaries, the message contained between the boundaries is extracted for non-faulty client requests. At step 112, a Windows fingerprint is generated from the extracted relevant information. A WSUS fingerprint such as fingerprint 74 is a subset of available information features such as features 72 obtained through ReportEventBatch client reports and initial RegisterComputer events.

In some embodiments, a more elaborated analysis of the SOAP message is required to extract name and version of installed applications or drivers that are contained in the rest of the SOAP message. In this case, SystemSpec information provided by the WSUS client through SyncUpdates requests is extracted and the name and version of the installed applications or drivers are determined from the SystemSpec information.

At step 114, the determined Windows fingerprint is compared to reference fingerprints stored in a database 116. If the determined Windows fingerprint corresponds to a given reference fingerprint, then the operating system identification associated with the given reference fingerprint is assigned to the determined Windows fingerprint, and therefore to the update packet being analyzed. The identification of the operating system associated with the update packet is stored in memory (e.g., in asset database 38, FIG. 1) at step 118 along with the identification of the computer machine to which the update packet is associated, i.e. the identification of the computer machine toward which the update packet propagates and is intended or from which the update packet propagates.

In some embodiments, the method 100 further comprises an application and/or hardware detection mode. When this mode is activated at step 120, the Windows fingerprint determined at step 112 is further used for application and/or hardware detection and identification at step 122. The identified application and/or hardware are then stored in memory (e.g., in asset database 38, FIG. 1) at step 118.

Referring back to step 108 and if the update packet is identified as a Unix-like update packet using deep packet inspection, then it is determined at step 124 whether the update packet is a File Transfer Protocol (FTP) packet.

If the update packet is identified as an FTP packet, the FTP transfer setup is extracted from the update packet at step 126. At step 128, the FTP request messages are parsed and analysed. Using DPI, the URL/path is extracted. When downloads are preceded by path selection of the file and domain names, it is possible to determine the architecture, the OS family and then the version of the operating system, while the file path allows determining the service/application being downloaded, including its version. A Unix fingerprint is then generated at step 130 using the results of the analysis performed at step 128. For example, a Unix fingerprint may be defined by a domain name, a file path, and a filename.extension.

Referring back to step 124 and if the update packet is not an FTP packet, step 132 is performed to determine whether the update packet corresponds to a Hypertext Transfer Protocol (HTTP) update.

If the updated packet corresponds to a HTTP update, then the HTTP header is extracted from the update packet at step 134. The fields of the HTTP header are parsed and analyzed at step 136. Particularly, the “user-agent” field and the “url” field contained in the HTTP header are analyzed. Similarly to step 128 and using DPI, the URL/path is extracted. When downloads are preceded by path selection of the file and domain names, it is possible to determine the architecture, the OS family and then the version of the operating system, while the file path allows determining the service/application being downloaded, including its version. Then the results of the analysis performed at step 136 are used to generate a fingerprint for the update packet at step 130. If an update client user-agent is observed, the fingerprint is defined by a domain name, a file path, and a filename.extension.

It should be understood that the OS fingerprint generation using an FTP update packet and the OS fingerprint generation using an HTTP update packet may be performed substantially concurrently.

At step 138, the determined fingerprint for the update packet is compared to reference fingerprints stored in a database 140. Each reference fingerprint stored in the database 140 is associated with a respective operating system which is defined by at least a name and a version. If a positive match is found between the determined fingerprint for the update packet and a given reference fingerprint, then the operating system associated with the given reference fingerprint is assigned to the update packet and the operating system is said to have been successfully identified.

At step 142, it is determined whether the operating system associated with the update packet has been successfully identified. If so, the identification of the operating system associated with the update packet is stored in memory at step 144 along with the identification of the computer machine to which the update packet is associated, i.e. the identification of the computer machine toward which the update packet propagates and is intended or from which the update packet propagates.

In some embodiments, the method 100 further comprises an application and/or hardware detection mode. When this mode is activated at step 146, the distribution name and version determined at step 138 are further used for application and/or hardware detection and identification at step 150. The identified application and/or hardware are then stored in memory at step 144.

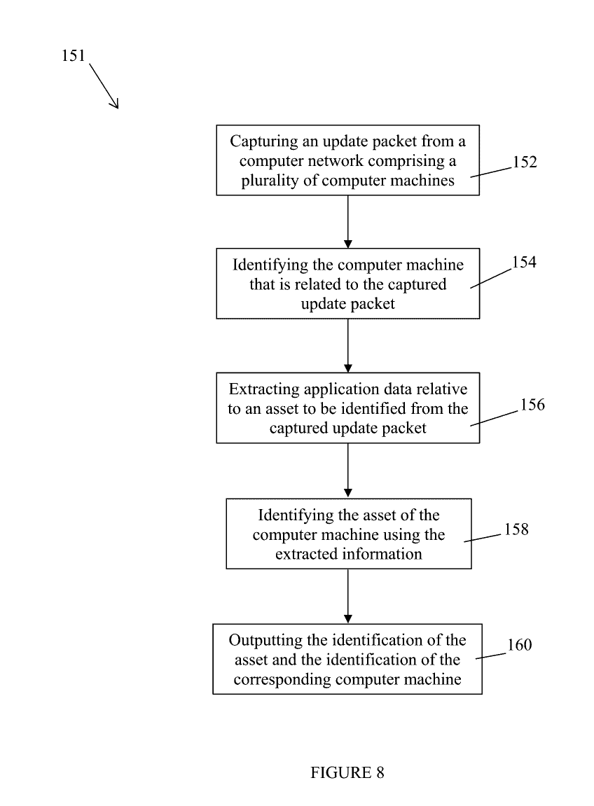

FIG. 8 illustrates one embodiment of a computer-implemented method 151 for identifying the operating system of a given computer machine comprised in a computer network. While the method 50 is used in the event that the identity of the computer machine associated with the update packet to be analyzed is already known, the method 150 may also be used when the identity of the computer machine is unknown.

It should be understood that the method 151 is executed using a computer machine, such as the asset detector 30 or 34, provided with at least a processing unit, a communication module for receiving and/or transmitting data, and a memory having stored thereon statements and/or instructions that, when executed by the processing unit, perform the steps of the method 151.

At step 152, an update packet from a data stream propagating in a computer network comprising a plurality of computer machines is captured. It should be understood that any adequate method for capturing an update packet may be used. For example, the above-described method 60 may be used.

At step 154, the given computer machine associated with the update packet is identified, i.e. the given computer machine to which the update packet is directed or from which the update packet propagates is identified. In some embodiments, the given computer machine is identified using its associated IP address, normally the Source IP address on a update client perspective.

At step 156, application layer data are extracted from the application layer of the captured update packet. Using the extracted application layer data, an asset such as an operating system is identified at step 158, and the identification of the asset and the associated computer machine are outputted at step 160. For example, the determined identities of the asset and the given computer machine may be stored in a local or external memory. In the same or another embodiment, the determined identity of the asset is sent to the asset consolidator 36 along with the identity of the given computer machine.

It should be understood that the step 156 of the method 150 may correspond to the step 54 of the method 50. Similarly, it should be understood that the step 158 of the method 150 may correspond to the step 56 of the method 50.

In some embodiments, the above-described methods and systems use register computer (RC) update packets in order to identify an asset. In the same or another embodiment, the above-described methods and systems use report batch event (RBE) update packets to identify an asset.

TABLE 1
Parameters for RC and RBE updates

| Parameter | RBE | RC |
|---|---|---|
| ip 0 | x | x |
| messagetype | x | x |
| majorversion 2 | X | X |
| minorversion | X | X |
| suitemask_RC 4 | | X |
| oldproductype_RC | | X |
| newproductype_RC 6 | | X |
| systemmetric | | X |
| processor 8 | x | x |
| revision 10 | x | x |
| OLDPRODUCTYPE | x | |
| SUITEMASK_RBE 12 | x | |
| servicepackmajor | X | X |
| servicepackminor 14 | x | X |

Table 1 presents some of the parameters that are included in an RC update packet and an RBE update packet. Since some parameters may be present in an RC update packet but not in an RBE update packet and vice-versa, the parameters included in a fingerprint may vary depending on whether an RC update packet is analysed or whether an RBE update packet is analyzed. The precision of the identification of an asset may vary depending on whether RC update packets or RBE update packets are analyzed. For example, in the case of the analysis of RBE update packets only, the specification of the “Windows Server 2003 edition” may not be determined while the analysis of RC update packets allows for the determination of the specification of the “Windows Server 2003 edition” R1 and R2 editions.

The embodiments of the invention described above are intended to be exemplary only. The scope of the invention is therefore intended to be limited solely by the scope of the appended claims.

I/We claim:

1. A computer-implemented method for identifying an asset of a computer machine performed using at least one processing unit for:
capturing an update packet from a data path connected to the computer machine;
extracting application layer data related to the asset to be identified from the update packet;
identifying the asset using the extracted application data layer; and
outputting the identification of the asset.

2. The computer-implemented method of claim 1, wherein said capturing an update packet comprises capturing an update packet propagating towards the computer machine.

3. The computer-implemented method of claim 1, wherein said capturing an update packet comprises capturing an update packet propagating from the computer machine.

4. The computer-implemented method of claim 1, wherein said capturing an update packet comprises capturing a given packet and identifying the given packet as being the update packet.

5. The computer-implemented method of claim 4, wherein said identifying the given packet as being the update packet comprises:
decoding an Internet Protocol (IP) header of the given packet and extracting information contained in the decoded IP header;
determining whether the given packet belongs to a Transmission Control Protocol (TCP) traffic using the information extracted from the IP header;
if the given packet does not belong to TCP traffic, discarding the given packet; and
if the given packet belongs to the TCP traffic, reconstructing a TCP flow, and determining that the given packet is the update packet using the reconstructed TCP flow via protocol identification.

6. The computer-implemented method of claim 5, wherein said extracting information contained in the decoded IP header comprises extracting at least one of a IP version, a source IP, a destination IP, and a time-to-live.

7. The computer-implemented method of claim 1, wherein said identifying the asset comprises generating a given fingerprint using the application layer data and comparing the given fingerprint to reference fingerprints each corresponding to a respective asset identification.

8. The computer-implemented method of claim 7, wherein each respective asset identification comprises at least one of a name and a version.

9. The computer-implemented method of claim 7, wherein said generating the given fingerprint comprises extracting some of the application layer data.

10. The computer-implemented method of claim 9, wherein the extracted application data layer comprises a given value for at least one of a MajorVersion, a MinorVersion, a SuiteMask, an OldProductType, a NewProductType, a SystemMetrics, and a ProcessorArchitecture.

11. The computer-implemented method of claim 1, further comprising determining whether the update packet is one of a Windows packet and a Unix-like packet.

12. The computer-implemented method of claim 11, wherein the update packet is a Windows packet, said extracting application layer data comprising extracting a WSUS SOAP message from the update packet and parsing WSUS fields contained in the WSUS message, and said identifying the asset comprises generating a given Windows fingerprint using the parsed WSUS fields and comparing the given Windows fingerprint to reference Windows fingerprints.

13. The computer-implemented method of claim 12, further comprising detecting and identifying at least one of an application and a hardware component for the computer machine using the given Windows fingerprint.

14. The computer-implemented method of claim 11, further comprising determining whether the update packet is one of an FTP packet and a HTTP packet when the update packet is a Unix-like packet.

15. The computer-implemented method of claim 14, wherein the update packet is an FTP packet, said extracting application layer data comprising extracting an FTP transfer setup and parsing and analysing an FTP request message, and said identifying the asset comprises generating a given Unix fingerprint using the parsed FTP request message and comparing the given Unix fingerprint to reference Unix fingerprints.

16. The computer-implemented method of claim 14, wherein the update packet is a HTTP packet, said extracting application layer data comprising extracting a HTTP header and parsing and analysing HTTP fields, and said identifying the asset comprises generating a given Unix fingerprint using the HTTP fields and comparing the given Unix fingerprint to reference Unix fingerprints.

17. The computer-implemented method of claim 15, further comprising detecting and identifying at least one of an application and a hardware component for the computer machine using the given Unix fingerprint.

18. An asset detector comprising at least a processing unit, a memory, and communication interface for receiving and transmitting data, the memory having stored thereon instructions that upon execution by the processing unit cause the asset detector to:
capture an update packet from a data path connected to the asset detector;
extracting application layer data related to an asset to be identified from the update packet;
identifying the asset using the extracted application data layer; and
outputting the identification of the asset.

19. A non-transitory computer readable memory storage medium storing one or more programs, the one or more programs including executable instructions that when executed by a computer cause the computer to:
capture an update packet from a data path connected to the computer;
extracting application layer data related to an asset to be identified from the update packet;
identifying the asset using the extracted application data layer; and
outputting the identification of the asset.

20. A computer-implemented method for detecting and identifying computer assets on a computer network, performed using at least one processing unit for:
capturing update packets from the computer network, the computer network comprising a plurality of computer machines; and
for each one of the captured update packets:
identifying a corresponding one of the computer machines that is related to the captured update packet;
extracting application layer data from the captured update packet;
identifying an asset of the corresponding computer machine using the extracted application data layer; and
outputting the identified asset and an identification of the corresponding computer machine.
